(19) United States
(12) Patent Application Publication
(10) Pub. No.: US 2009/0044670 A1
(43) Pub. Date: Feb. 19, 2009

(54) Metal slicing machine

(76) Inventors: Guangquan Zhang, Shenzhen (CN); Hongkun Li, Shenzhen (CN); Yongcheng Jin, Shenzhen (CN)

Correspondence Address: JACOBSON HOLMAN PLLC, 400 SEVENTH STREET N.W., SUITE 600, WASHINGTON, DC, 20004, US

(21) Appl. No.: 12/007,885

(22) Filed: Jan. 16, 2008

(30) Foreign Application Priority Data
Aug. 13, 2007 (CN) 200710075738.4

(51) Int. Cl. B26D 7/06

(52) U.S. Cl. 83/109; 83/471.2; 83/526

(57) ABSTRACT

A metal slicing machine includes a frame, a sliding mechanism, a drive means, a cutting assembly, a pressing means, and a feeding mechanism. The sliding mechanism is disposed on the frame, the cutting assembly is fixed on a movable portion of the sliding mechanism. Output of the drive means is coupled to the cutting assembly, driving the cutting assembly to reciprocatingly move relative to a fixed portion of the sliding mechanism. The pressing means presses a metal material to be processed during cutting of the cutting assembly. The feeding mechanism feeds the metal material at a set pace during releasing of the pressing means.

### FIELD OF THE INVENTION

The present invention relates to a slicing machine, particularly to a metal slicing machine, and more particularly to a metal slicing machine for processing fins of a heat exchanger.

### BACKGROUND OF THE INVENTION

Heat exchanger is an important component in an air-conditioner and a refrigerator. A heat exchanging medium in a heat exchanger absorbs or releases heat through changing the state, thereby carrying out heat convection. For example, the heat exchangers of an air-conditioner include an indoor heat exchanger (i.e., evaporator) and an outdoor heat exchanger (condenser). The evaporator is the direct refrigerating member in a refrigerating system, and a low-pressure liquid refrigerant absorbs heat and evaporates in the evaporator, thereby cooling ambient air. The condenser transfers the heat absorbed by the refrigerant in the evaporator and compressor to outdoor air. The heat exchanger mainly, includes a refrigerant pipe and fins. Typical fins in heat exchangers of the air-conditioners are bonded to the refrigerant pipe by processes such as expansion fastening, welding, or rivet jointing. However, the most obvious disadvantages of the traditional processes lie in that, thermal resistance is caused when the fin and the pipe are bonded, the manufacturing processes, are complicated, and the conformance of products is low. Therefore, a heat changer in which the pipe and the fins are integrally formed is needed, but the cost is high and the efficiency is low on conditions that the traditional numerical control machining or other machine tools are adopted to process the fins of such heating sinks.

### SUMMARY OF THE INVENTION

The present invention is directed to a metal slicing machine specially for processing fins of a heat exchanger.

The object of the present invention is achieved through the following technical solution.

The metal slicing machine includes a frame, a sliding mechanism, a drive means, a cutting assembly, a pressing means, and a feeding mechanism. The sliding mechanism is disposed on the frame, and the cutting assembly is fixed on a movable portion of the sliding mechanism. A power output end of the drive means is coupled to the cutting assembly, so as to drive the cutting assembly to move along a straight line back and forth relative to a fixed portion of the sliding mechanism. The pressing means presses a metal material during cutting of the cutting assembly. The feeding mechanism feeds the metal material at a set pace during releasing of the pressing means releasing the metal material to be processed.

In an embodiment, the metal slicing machine further includes a track adjustment means for adjusting slice track position of the cutting assembly. The track adjustment means is fixed on the frame, and the sliding mechanism is connected to the frame through the track adjustment means.

The track adjustment means includes an elevating mechanism; and the elevating mechanism is used to adjust a height of the movement track of the cutting assembly in a vertical direction.

One embodiment of the elevating mechanism includes a handwheel, an elevating worm, an elevating turbine, a lead screw, and an elevating nut. The handwheel is engaged with one end of the elevating worm. The lead screw is supported by a bearing, the matching elevating nut is fitted over the lead screw, and the elevating turbine meshing with the elevating worm is fitted over one end of the lead screw. The elevating nut is combined with the cutting assembly.

In another embodiment, the track adjustment means further includes a slide seat; the frame has a vertical slide way thereon; and the slide seat is connected to the elevating nut, and drives the sliding mechanism fixed thereon to move along the slide way under control of the elevating mechanism.

In another embodiment, the track adjustment means further includes an angle adjustment mechanism for adjusting an angle between the movement track of the cutting assembly and a horizontal plane; and the angle adjustment mechanism is disposed on the elevating mechanism and the sliding mechanism is connected to the elevating mechanism through the angle adjustment mechanism.

One embodiment of the angle adjustment mechanism includes a rotating disk, a horizontal carriage saddle, and a bolt; a concentric hole is formed in the rotating disk; a rabbet center is adopted between the horizontal carriage saddle and the rotating disk, so that the horizontal carriage saddle rotates in a range of circumferential angles corresponding to the concentric hole about the center of the rotating disk, and the bolt is used to fix the rotating disk and the horizontal carriage saddle at the concentric hole.

In one embodiment, one realization method of the pressing means is to include a cam, a first pressing bar, a first lever, a second pressing bar, and a second lever; the cam is mounted on a main shaft of the drive means; one end of the first pressing bar abuts to the cam, and the other end is hinged to a long arm of the first lever; a short arm of the first lever is hinged to one end of the second pressing bar; and one end of the second lever is hinged to the other end of the second pressing bar, and the other end of the second lever acts on the metal material to be processed.

In another embodiment, the pressing means further includes a roller; and the roller is hinged to an end of the first pressing bar close to the cam, and the cam acts on the first pressing bar through the roller.

As an improvement on the pressing means, the pressing means may further include a buffering device on the second pressing bar.

The pressing means may further include a pressing claw disposed at one end of the second pressing bar, and the second lever presses the metal material through the pressing claw.

In one embodiment, one implementation of the feeding mechanism includes a ratchet wheel, a feeding worm, a feeding turbine, a feeding transmission shaft, a bearing, a friction wheel, and a ratchet fixed on the cutting assembly and moving along a straight line back and forth with the cutting assembly; the ratchet wheel is attached to one end of the feeding turbine, and rotates intermittently under control of the ratchet; the feeding transmission shaft is rotatably supported by the bearing, the friction wheel is fitted over one end of the feeding transmission shaft, and the feeding turbine meshing with the feeding worm is fitted over the other end of the feeding transmission shaft.

In another improved embodiment, the metal slicing machine further includes a pushing plate, which is fixed at a front side of the cutting assembly, for shaping a fin formed by previous cutting during each cutting.

Compared with the conventional art, the present invention has the following advantages.

Compared with the digital control machining center, the cost is reduced but the efficiency is enhanced if fins of a heat exchanger are processed by using the metal slicing machine in the technical solution of the present invention.

Due to the track adjustment means, the position of the movement track of the cutting assembly movement track may be adjusted for different requirements.

Since the track adjustment means includes a height adjustment mechanism, the position of the movement track of the cutting assembly may be adjusted in a vertical direction, so as to satisfy the requirements of cutting metal materials with different thicknesses.

Since the elevating mechanism adopts the turbine and the worm for transmission, it becomes easy to rotate the handwheel to perform elevating actions.

Due to the slide way and the slide seat, the elevating actions are more vertical and reliable.

The track adjustment means includes an angle adjustment mechanism, which may adjust an included angle of the movement track of the cutting assembly and the horizontal plane, so the thickness of the cut fin may be adjusted.

Due to the concentric hole in the angle adjustment mechanism, the cutting movement track of the cutting assembly changes its angle in a specific angle, so as to satisfy requirements of thicknesses and pitches of different fins.

The cam works with the connecting bar and the levers to press metal materials, which leads to a simple structure and favorable effects.

The disposition of the buffering device may isolate and reduce vibration and adjust a pressure, thereby making a pressing state more reliable.

Due to the pressing claw, the metal materials of different specifications may be pressed more reliably.

The ratchet wheel works with the turbine and worm to transmit the friction wheel, and depending on a friction force between the friction wheel and the metal material, the metal material is fed at a set pace, which leads to a simple structure and reliable actions. Therefore, the pace of feeding the metal material may be adjusted conveniently through replacing the ratchet wheels of different specifications.

Due to the disposition of the pushing plate, a fin formed by previously cutting is shaped during each cutting. A specific angle may be formed between the processed fin and the metal material.

### BRIEF DESCRIPTION OF THE DRAWINGS

FIG. 1 is a schematic general structural view of a metal slicing machine according to an embodiment of the present invention.

FIG. 2 is a sectional view of the metal slicing machine according to an embodiment of the present invention.

FIG. 3 is a sectional view of the vertical carriage saddle according to an embodiment of the present invention.

FIG. 4 is a schematic structural view of the elevating mechanism according to an embodiment of the present invention.

FIG. 5 is a schematic view of the operating principle of the drive means according to an embodiment of the present invention.

FIG. 6 is a schematic structural view of the feeding mechanism according to an embodiment of the present invention.

FIG. 7 is a schematic view of the operating principle of the pressing means according to an embodiment of the present invention.

FIG. 8 is a timing diagram of the operating cycle of the metal slicing machine according to an embodiment of the present invention.

FIG. 9 is a schematic structural view of the cutting assembly according to an embodiment of the present invention.

### DETAILED DESCRIPTION OF THE INVENTION

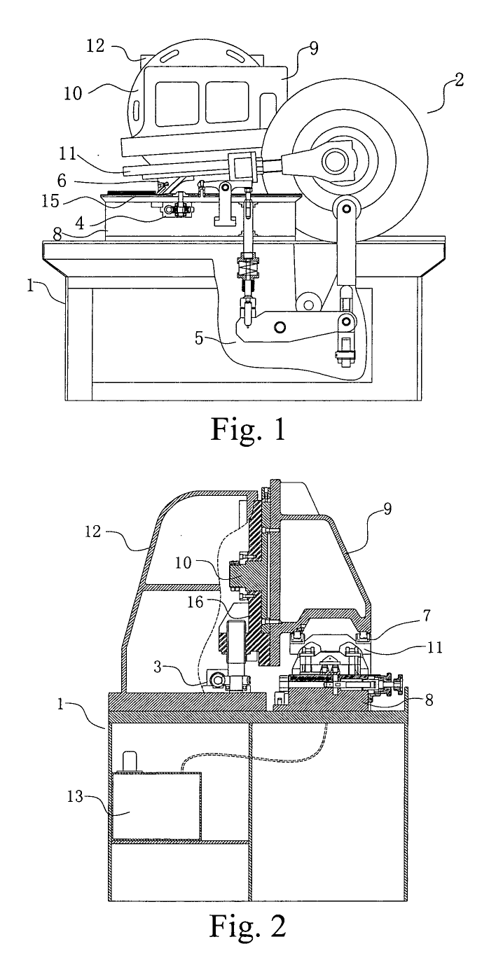

Referring to FIGS. 1-9, a metal slicing machine in an embodiment of the present invention will be further described.

As shown in FIGS. 1 and 2, the metal slicing machine mainly includes a frame, a track adjustment means, a sliding mechanism, a drive means 2, a feeding mechanism 4, a pressing means 5, and a cutting assembly 6.

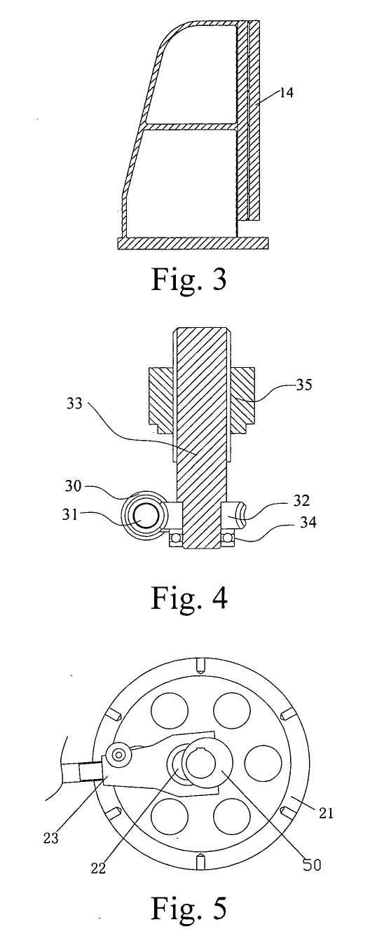

The frame includes a base 1, a workbench 8, and a vertical carriage saddle 12. The base 1 is the main body of the frame and welded to be a frame structure, which has an elegant appearance, may be fabricated conveniently, and causes a low cost, and meanwhile is convenient for assembling/disassembling and maintenance. Shaped steel has undergone a modified treatment before being welded, thereby ensuring that the base will not be deformed easily in the further usage. The workbench 8 is disposed at one side of the base 1, and functions as a carrier platform for a metal material 15 to be processed. The vertical carriage saddle 12 is mounted at the other side of the base 1, and is connected to the base 1 through bolts. As shown in FIG. 3, the vertical carriage saddle 12 has a vertical slide way 14 at one side thereof, and adapting for working with the track adjustment means to adjust height of a movement track of the cutting assembly 6.

The track adjustment means includes an elevating mechanism 3 and an angle adjustment means.

The specific structure of the elevating mechanism 3 is shown in FIG. 4, which includes a handwheel 30, an elevating worm 31, an elevating turbine 32, a lead screw 33, a bearing 34, and an elevating nut 35. The handwheel 30 is coupled to one end of the elevating worm 31, and the elevating worm 31 is disposed horizontally and is rotatably supported on the vertical carriage saddle 12. The lead screw 33 is rotatably supported on the vertical carriage saddle 12 in a vertical direction through the bearing 34, and the elevating nut 35 meshing with the lead screw is disposed thereon, and an elevating turbine 32 meshing with the elevating worm 31 is fixed at lower end of the lead screw. In order to adjust the movement track of the butting assembly 6, the handwheel 30 may be rotated to drive the elevating worm 31 and the elevating turbine 32 to rotate, so as to increase the force applied on the rotating handwheel 30 imposed by a user through the turbine and the worm, meanwhile driving the lead screw 33 to rotate. Due to the rotation of the lead screw 33, the elevating nut 35 moves along the lead screw 33, thereby driving the angle adjustment mechanism connected to the elevating nut 35 to move in a vertical direction.

The elevating mechanism may adjust the part fixed with the nut in a vertical direction by directly rotating the nut.

As shown in FIG. 2, the track adjustment means in this embodiment further includes a slide seat 16. The slide seat 16 is connected to the elevating nut 35, and the angle adjustment mechanism is connected to the elevating mechanism 3 through the slide seat 16. Under control of the elevating mechanism 3, the slide seat 16 drives the angle adjustment mechanism and meanwhile drives the sliding mechanism and the cutting assembly 6 connected to the angle adjustment mechanism to move along the slide way 14, thereby changing height of the movement track of the cutting assembly 6. The effective result of the elevating mechanism 3 is to adjust the position of the cutting assembly 6 in the vertical direction, so as to be fit for the metal materials 15 with different thicknesses.

The angle adjustment mechanism includes a rotating disk 10, a horizontal carriage saddle 9, and a bolt. The rotating disk 10 in the angle adjustment mechanism is connected to the slide seat 16. The horizontal carriage saddle 9 is rotatably fixed on the rotating disk 10, for example, fixed on the rotating disk 10 through a rabbet center, so that the horizontal carriage saddle 9 may rotate relative to the rotating disk 10 about the center of the rotating disk. A plurality of concentric holes concentric with the rotating disk 10 is defined in the rotating disk 10. The horizontal carriage saddle 9 and the rotating disk 10 may be fixed by using bolts through the concentric hole. Due to the concentric hole, the angle of the horizontal carriage saddle 9 relative to the rotating disk 10 may be adjusted when the bolts are released. After the angle has been adjusted, the horizontal carriage saddle 9 may be fixed on the rotating disk 10 through the bolts. In order to apply a uniform force, six concentric holes are defined symmetrically in the specific embodiment, and furthermore, three or four concentric holes may be disposed along the circumference of the rotating disk 10 uniformly. The angle adjustment mechanism is provided for adjusting angle between the movement track of the cutting assembly 6 and the horizontal plane, thereby incorporating the elevating mechanism to adjust the height of the cut fins. The angle corresponding to the concentric hole in the circumferential direction defines a angle range that can be adjusted, and the arc length of the concentric hole may be set upon requirements, or concentric holes having a certain circumferential angle may be defined upon requirements.

It can be further seen from FIG. 2 that the slide means is fixed between the bottom of the horizontal carriage saddle 9 and a joint plate 11. The slide means in this embodiment is a straight guide rail 7. The upper part of the straight guide rail 7 is fixed with the bottom of the horizontal carriage saddle 9, and the lower part is fixed with the top of the joint plate 11, so that the joint plate 11 may move reciprocatingly therealong relative to the horizontal carriage saddle 9. Finally, under control of the drive means 2, the joint plate 11 drives the cutting assembly 6 connected thereto to move back and forth along the straight guide rail 7, thereby cutting the metal material 15. The straight guide rail 7 may be a standard piece, which is purchased easily, and furthermore, it has a high precision, convenient in replacement, and has reliable quality.

An output of the drive means 2 is hinged to the joint plate 11, so as to drive the joint plate 11 and the cutting assembly 6 connected thereto to slide along the line rail 7. The specific structure of the drive means 2 is shown in FIG. 5 and includes a belt pulley 21, a crank shaft 22, and a connecting bar 23. The belt pulley 21 is driven by an electromotor (not shown in FIG. 11) through a belt. The belt pulley 21 is coaxially mounted with the crank shaft 22 and a cam 50. The cam 50 is used to drive the pressing means 5, and the crank shaft 22 hinged to the connecting bar 23 acts on the joint plate 11, and converts the circumferential motion of the belt pulley 21 into the reciprocating straight motion of the joint plate 11, thereby driving a cutter plate 62 (not shown in FIG. 9) fixed on the cutting assembly 6 of the joint plate 11 to carry out the cutting action. The electromotor is mounted in the base 1 through a slide plate, and retains the tension of the belt between the electromotor and the belt pulley 21 by adjusting the position of the electromotor.

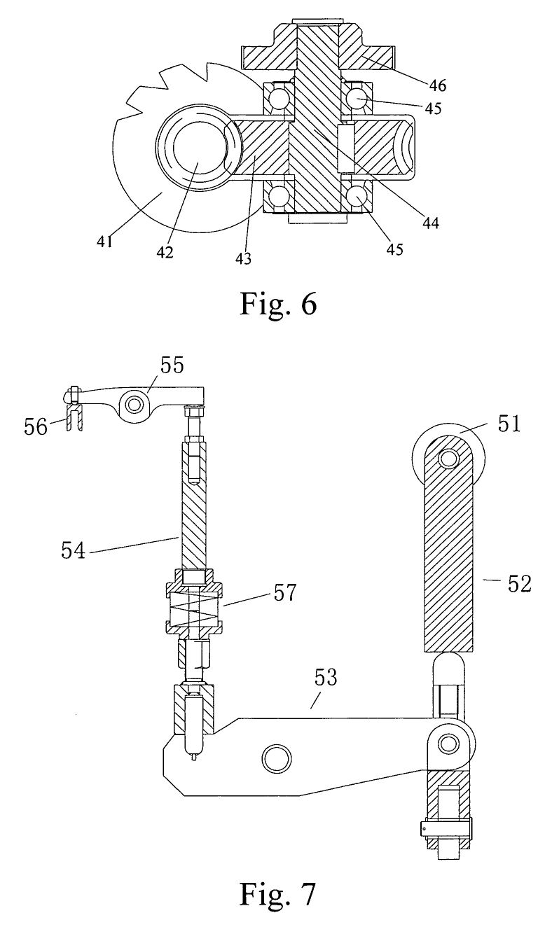

The feeding mechanism 4 is mounted at one side of the workbench 8. The specific structure thereof is shown in FIG. 6 and includes a ratchet wheel 41, a feeding worm 42, a feeding turbine 43, a feeding transmission shaft 44, a bearing 45, and a friction wheel 46. Furthermore, the feeding mechanism 4 further includes a ratchet (not shown in FIG. 6) disposed on the joint plate 11 and meshing with the ratchet wheel 41. The joint plate 11 moves back and forth to drive the ratchet to move, and acts on the ratchet wheel 41. The ratchet wheel 41 is mounted at one end of the feeding worm 42, the feeding worm 42 further drives the feeding turbine 43, and the feeding turbine 43 drives the friction wheel 46 to rotate through the feeding transmission shaft 44. The friction wheel 46 touches the metal material 15 to be processed, so as to feed the metal material 15 by friction force deriving from between the friction wheel 46 and the metal material 15. The feeding pace of the metal material 15 may be adjusted by adjusting the parameters of the ratchet wheel 41, thereby adjusting the thickness and pitch of processed fins.

The pressing means 5 is mounted on one side surface of the workbench 8 and in the base 1, and the pressing movement is carried out by the lever principle. The specific structure of the pressing means 5 is shown in FIG. 7 and includes a cam 50, a roller 51, a first pressing bar 52, a first lever 53, a second pressing bar 54, a second lever 55, and a pressing claw 56. The cam 50 and the belt pulley 21 in the drive means 2 are mounted on the same shaft. The roller 51 is disposed at one end of the first pressing bar 52, abuts on the cam 50, and moves up and down at a certain frequency under control of the cam 50. The other end of the first pressing bar 52 is hinged to a long arm of the first lever 53, and the first pressing bar 52 and the first lever 53 are preferably perpendicular to or substantially perpendicular to each other. One end of the second pressing bar 54 is hinged to a short arm of the first lever 53, and the second pressing bar 54 and the first lever 53 are preferably perpendicular to or substantially perpendicular to each other. The other end of the second pressing bar 54 is hinged to one end of the second lever 55, and the second pressing bar 54 and the second lever 55 are preferably perpendicular to or substantially perpendicular to each other. The pressing claw 56 is fixed on other end of the second lever 55.

When the drive means 2 is working, the cam 50 presses the roller 51 to make it move up and down. The force and the movement applied to the roller 51 act on the first lever 53 through the first pressing bar 52, and the acting force of the cam 50 on the roller 51 is increased through the first lever 53. The other end of the first lever 53 acts on one end of the second lever 55 through the second pressing bar 54, and finally acts on the metal material 15 to be processed through the pressing claw 56 on the other end of the second lever 55, and presses the metal material 15 on the workbench 8 in a reliable manner. In this specific embodiment, a buffering device 57, such as an elastic member, is further disposed on the second pressing bar 54, so as to function as a damper and adjust a pressure, such that the metal material 15 to be processed may be pressed more reliably. When the roller 51 is being pressed downward by the cam 50, the pressing claw 56 closes to the metal material and finally presses the metal material, thereby the metal material entering the pressing period. When the pressure applied on the roller 51 by the cam 50 fades, the pressing claw 56 leaves the metal material, thereby the metal material entering the releasing period. At this point, the metal material 15 may be fed under the driving of the feeding mechanism 4.

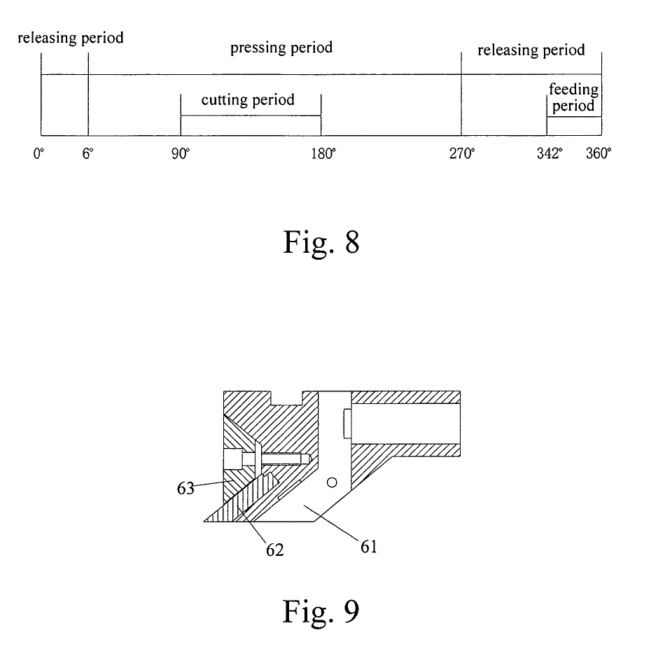

The cam 50 rotating one cycle, and an operating cycle is defined. In one operating cycle, the pressing means 5 finishes pressing and releasing the material for once. FIG. 8 is a timing diagram of the operating cycle of the metal slicing machine. The operating cycle refers that the belt pulley 21 and the cam 50 rotates for one cycle, the time sequence of pressing and releasing the material may be set by changing the contour line of the cam 50. The pressing period shown in FIG. 8 is 6°-270°, the pressing claw 56 presses the metal material 15 tightly, and the other time intervals are in the releasing period. The cutting period is one interval in the pressing period, and as shown in FIG. 8, the cutting period is 90°-180°. Similarly, the feeding period is also in the releasing period. The feeding period is 342°-360°, as shown in FIG. 8.

The cutting assembly 6 is mounted on a lower front part of the joint plate 11 by bolts. The specific structure is shown in FIG. 9 and includes a cutter body 61, a press block 63, and the cutter plate 62 fixed on the cutter body 61 by the press block 63 and screws. The cutter plate 62 has bladeblade for cutting. The drive means 2 drives the joint plate 11 to move reciprocatingly straight therealong, thereby enabling the blade of the cutter plate 62 to finish cutting along a predetermined track. A pushing plate may be mounted on the front part of the cutting assembly 6 to adjust the angle between the fin and the metal material.

A cooling means 13 is mounted in the base 1, as shown in FIG. 2. As the metal slicing machine is working, a cooling fluid is sprayed on the cutter plate 62 of the cutting assembly 6 and the metal material 15 to be processed, so as to cool the cutter assembly 6 and enhance the service life of the cutter plate 62.

The metal slicing machine may cut the metal material 15 into fins of different shapes by using different cutter plates 62 and also may cut the metal material 15 into double faced fins, three faced fins, and multiple faced fins by using different pressing claws 56. The pressing claw 56 may be designed with different shapes to satisfy specific requirements according to different fins and the fins ordered by clients.

In the other embodiment, if the thickness of the metal material keeps the same, i.e., under the circumstance that the distance between the cutting assembly and the workbench need not be adjusted, the track adjustment means may merely include the angle adjustment mechanism.

The above-mentioned contents describe the present invention in detail with a specific preferred embodiment, but it cannot be considered that, the specific embodiments of the present invention are limited to the illustration. For those of ordinary skill in the art of the present invention, several simple deductions or alterations may be made without departing from the concept of the present invention, and shall be deemed to be fall in the protection scope of the present invention.

1. A metal slicing machine, comprising:
a frame, for serving as a base;
a sliding mechanism on the frame, disposed on the frame, and comprising at least a fixed portion and a movable portion;
a cutting assembly, fixed on the movable portion of the sliding mechanism;
a drive means disposed on the frame, comprising a power output end engaged with the cutting assembly for driving the cutting assembly to reciprocatingly move along a straight direction relative to the fixed portion of the sliding mechanism;
a pressing means, keeping a metal material to be processed during cutting of the cutting assembly; and
a feeding mechanism, feeding the metal material at a set pace during a releasing period when the pressing means releases the metal material to be processed.

2. The metal slicing machine as claimed in claim 1, further comprising a track adjustment means for adjusting slice track of the cutting assembly, wherein the track adjustment means is fixed on the frame, and the sliding mechanism is engaged with the frame through the track adjustment means.

3. The metal slicing machine as claimed in claim 2, wherein the track adjustment means comprises an elevating mechanism.

4. The metal slicing machine as claimed in claim 3, wherein the elevating mechanism comprising:
a handwheel for rotation;
an elevating worm, the handwheel fitted over an end of the elevating worm, driving the elevating worm to rotate therealong;
a lead screw, rotatably supported on the frame;
an elevating turbine, attached to an end of the lead screw, the elevating turbine meshing with the elevating worm; and
an elevating nut, in mesh with the lead screw, the elevating nut mounted to the cutting assembly.

5. The metal slicing machine as claimed in claim 4, wherein the track adjustment means further comprises a slide seat; the frame comprises a vertical slide way; and the slide seat is attached to the elevating nut, and carries the sliding mechanism fixed thereon to slide along the slide way under control of the elevating mechanism.

6. The metal slicing machine as claimed in claim 3, wherein the track adjustment means further comprises an angle adjustment mechanism for adjusting an angle between the track of the cutting assembly and a horizontal plane; the angle adjustment mechanism is fixed on the elevating mechanism; and the sliding mechanism is connected to the elevating mechanism through the angle adjustment mechanism.

7. The metal slicing machine as claimed in claim 6, wherein the angle adjustment mechanism comprises:
a rotating disk, wherein a plurality of concentricconcentric holes is defined in the rotating disk;
a horizontal carriage saddle, rotatably attached to a center of the rotating disk;
a bolt, connecting the rotating disk and the horizontal carriage saddle at one of the concentricconcentric holes, thereby the horizontal carriage saddle rotating in a range of circumferential angles corresponding to the concentric hole about the center of the rotating disk.

8. The metal slicing machine as claimed in claim 2, wherein the track adjustment means comprises an angle adjustment mechanism for adjusting an angle between the track of the cutting assembly and the horizontal plane; the angle adjustment mechanism is fixed on the frame; and the sliding mechanism is connected to the frame through the angle adjustment mechanism.

9. The metal slicing machine as claimed in claim 8, wherein the angle adjustment mechanism comprises:
a rotating disk, wherein a plurality of concentric holes is defined in the rotating disk;
a horizontal carriage saddle, rotatably fixed at the center of the rotating disk; and
a bolt, for connecting the rotating disk and the horizontal carriage saddle at one of the concentric holes, so that the horizontal carriage saddle rotates in a range of circumferential angles corresponding to the concentric hole about the center of the rotating disk.

10. The metal slicing machine as claimed in claim 1, wherein the pressing means comprises a cam, a first pressing bar, a first lever, a second pressing bar, and a second lever; the cam is mounted on a main shaft of the drive means; one end of the first pressing bar abuts to the cam, and the other end is hinged to a long arm of the first lever; a short arm of the first lever is hinged to one end of the second pressing bar; one end of the second lever is hinged to the other end of the second pressing bar, and the other end of the second lever acts on the metal material to be processed.

11. The metal slicing machine as claimed in claim 10, wherein the pressing means further comprises a roller; the roller is hinged to an end of the first pressing bar in close proximity to the cam; thereby the cam acts on the first pressing bar through the roller.

12. The metal slicing machine as claimed in claim 11, wherein the pressing means further comprises a buffering device disposed on the second pressing bar.

13. The metal slicing machine as claimed in claim 1Q, wherein the pressing means further comprises a pressing claw disposed at the free end of the second lever; and the second lever drives the pressing claw to restrain the metal material to be processed.

14. The metal slicing machine as claimed in claim 1, wherein the feeding mechanism comprises a ratchet wheel, a feeding worm, a feeding turbine, a feeding transmission shaft, a bearing, a friction wheel, and a ratchet fixed on the cutting assembly and moving reciprocatingly along with the cutting assembly; the ratchet wheel is attached to one end of the feeding turbine, and rotating intermittently under control of the ratchet; and the feeding transmission shaft is rotatably supported upon the bearing, the friction wheel is engaged with the feeding transmission shaft at one end thereof, and the feeding turbine meshing with the feeding worm is mounted on the other end of the feeding transmission shaft.

15. The metal slicing machine as claimed in claim 1, wherein the drive means comprises a belt pulley driven by an electromotor through a belt, a crank shaft coaxial with the belt pulley, and a connecting bar hinged with the crank shaft.

16. The metal slicing machine as claimed in claim 15, wherein the drive means further comprises a joint plate connected to the cutting assembly, wherein the connecting bar and the joint plate are coupled so as to drive the cutting assembly.

17. The metal slicing machine as claimed in claim 1, further comprising a pushing plate, the pushing plate mounted in the front of the cutting assembly, for shaping fins formed by previous slice during each cut.

18. The metal slicing machine as claimed in claim 1, wherein the sliding mechanism are straight guide rails.
